(19) United States
(12) Patent Application Publication
(10) Pub. No.: US 2026/0341668 A1
(43) Pub. Date: Oct. 29, 2026

(54) ELECTRODE MANUFACTURING APPARATUS AND ELECTRODE MANUFACTURING METHOD

(71) Applicant: SK On Co., Ltd., Seoul (KR)

(72) Inventors: Min Sang KIM, Daejeon (KR); Dong Woo KIM, Daejeon (KR); Jong Bok PARK, Daejeon (KR); Sang Hwa LEE, Daejeon (KR)

(21) Appl. No.: 19/657,014

(22) Filed: Apr. 24, 2026

(30) Foreign Application Priority Data
Apr. 24, 2025 (KR) 10-2025-0053775
Apr. 21, 2026 (KR) 10-2026-0072201

(51) Int. Cl. H01M 4/04; H01M 10/04

(52) U.S. Cl. CPC H01M 4/0409; H01M 10/0431; H01M 10/0468

(57) ABSTRACT

An electrode manufacturing apparatus includes: a supply bobbin configured to perform roll-to-roll traveling; an electrode sheet including a coated region and an uncoated region and configured to be wound on the supply bobbin; a label configured to be attached to a boundary line of the coated region and the uncoated region; a first displacement sensor configured to be spaced apart from the electrode sheet and configured to selectively detect any one of a first distance to the label and a second distance to the supply bobbin during the roll-to-roll traveling; a second displacement sensor configured to be spaced apart from the electrode sheet and configured to detect a third distance to an outermost surface of the electrode sheet during the roll-to-roll traveling; and a controller configured to adjust a rotational speed of the supply bobbin based on a difference between the first distance and the third distance.

### CROSS-REFERENCE TO RELATED PATENT APPLICATION

This application claims priority under 35 U.S.C. § 119(a) to Korean patent application number 10-2025-0053775 filed on Apr. 24, 2025, and 10-2026-0072201 filed on Apr. 21, 2026, in the Ministry of Intellectual Property, the entire disclosures of which is incorporated by reference herein.

### TECHNICAL FIELD

This disclosure relates to an electrode manufacturing apparatus and an electrode manufacturing method.

### DISCUSSION OF THE RELATED ART

An electrode manufacturing process is a process to produce an electrode, which is a core component of a secondary battery or the like, and may consist of, for example, an electrode process, an assembly process, an activation process, and a packing process. Thereamong, the electrode process may include mixing, coating, and roll pressing processes.

In the mixing process, an active material, a binder, and a conductive additive are mixed to prepare a homogeneous slurry. In the coating process, the slurry is applied onto a collector to form an active material layer. In the roll pressing process, the coated active material layer is rolled to flatten the electrode to improve the density. These processes directly affect the performance and quality of the electrode and require technological development to improve efficiency and precision.

In particular, in the coating process, uncoated regions on which the active material layer is not coated on the collector may be formed, and these uncoated regions need to be removed prior to the roll pressing process.

The description above is intended solely to help understand the background technology of the technical ideas of this disclosure, and is not to be construed as content corresponding to the prior art known to those skilled in the art.

### SUMMARY

According to an aspect of this disclosure, an electrode manufacturing apparatus and an electrode manufacturing method may be provided, capable of more precisely removing uncoated regions of an electrode sheet.

This disclosure may be widely applied in the field of electric vehicles, battery charging stations, energy storage systems (ESS), and green technologies such as photovoltaics and wind power that utilize batteries. This disclosure may also be used in eco-friendly mobility, including electric vehicles and hybrid vehicles to prevent climate change by curbing air pollution and greenhouse gas emissions.

However, the objects of this disclosure are not necessarily limited to those stated above, and other technical objects that are not mentioned will be clearly understood by those skilled in the art from the following description.

An electrode manufacturing apparatus may include: a supply bobbin configured to perform roll-to-roll traveling; an electrode sheet including a coated region and an uncoated region and configured to be wound on the supply bobbin; a label configured to be attached to a boundary line of the coated region and the uncoated region; a first displacement sensor configured to be spaced apart from the electrode sheet and configured to selectively detect any one of a first distance to the label and a second distance to the supply bobbin during the roll-to-roll traveling; a second displacement sensor configured to be spaced apart from the electrode sheet and configured to detect a third distance to an outermost surface of the electrode sheet during the roll-to-roll traveling; and a controller configured to adjust a rotational speed of the supply bobbin based on a difference between the first distance and the third distance.

The first displacement sensor may temporarily detect, when the label is positioned between the first displacement sensor and the supply bobbin, a first distance from the first displacement sensor to the label and may detect the second distance from the first displacement sensor to the supply bobbin at all times.

The controller may decelerate, when a difference between the first distance and the third distance is less than or equal to a first reference value, a rotational speed of the supply bobbin.

The boundary line may include a first boundary line on which transition occurs from a coated region to an uncoated region, and a second boundary line on which transition occurs from the uncoated region to the coated region, wherein the label may include a first label arranged on an upstream side of the first boundary line relative to a roll-to-roll traveling direction, and a second label arranged on a downstream side of the second boundary line relative to the roll-to-roll traveling direction, wherein the first displacement sensor may selectively detect any one of a first_first distance to the first label and the second distance to the supply bobbin during the roll-to-roll traveling, and may selectively detect any one of a first_second distance to the second label and the second distance to the supply bobbin during the roll-to-roll traveling, and wherein the controller may decelerate, when a difference between the first_first distance and the third distance is less than or equal to a first reference value, a rotational speed of the supply bobbin, and may decelerate, when a difference between the first_second distance and the third distance is less than or equal to the first reference value, a rotational speed of the supply bobbin.

The controller may decelerate, when a difference between the second distance and the third distance is less than or equal to a second reference value, the rotational speed of the supply bobbin.

The electrode manufacturing apparatus may further include a color sensor configured to be spaced apart from the electrode sheet and configured to distinguish and detect the coated region and the uncoated region during the roll-to-roll traveling.

The color sensor may detect a moment of transition from the coated region to the uncoated region and transmit a stop signal to the controller, and the controller may stop rotation of the supply bobbin based on the stop signal.

The electrode manufacturing apparatus may further include a scrap winder winding the uncoated region of the electrode sheet, wherein the uncoated region may be removed from the electrode sheet by cutting a first cutting line located on the upstream side of the first boundary line and a second cutting line located on the downstream side of the second boundary line with respect to the roll-to-roll travelling direction between the moments when rotation of the supply bobbin stops by the stop signal.

The electrode manufacturing apparatus may further include a splicing table on which cutting of the first cutting line and splicing of the first cutting line and the second cutting line take place.

The electrode manufacturing apparatus may further include a third displacement sensor configured to detect a second distance to the supply bobbin during the roll-to-roll traveling.

An electrode manufacturing method may include: monitoring a first separation distance from an outermost surface of an electrode sheet wound on a supply bobbin and performing roll-to-roll traveling to a label; and decelerating a rotational speed of the supply bobbin when the first separation distance is less than or equal to a first reference value, wherein the label may be attached to a boundary line of a coated region and an uncoated region of the electrode sheet.

The first separation distance may be obtained by calculating, during the roll-to-roll traveling, a difference between a distance from a first displacement sensor to the label and a distance from a second displacement sensor to an outermost surface of the electrode sheet.

The boundary line may include a first boundary line on which transition occurs from a coated region to an uncoated region, and a second boundary line on which transition occurs from the uncoated region to the coated region, wherein the label may include a first label arranged on an upstream side of the first boundary line relative to a roll-to-roll traveling direction, and a second label arranged on a downstream side of the second boundary line relative to the roll-to-roll traveling direction, wherein the first separation distance may be obtained by calculating, during the roll-to-roll traveling, a difference between a first_first distance from the first displacement sensor to the first label and a third distance from the second displacement sensor to an outermost surface of the electrode sheet.

The electrode manufacturing method may further include: stopping, when detecting a moment of transition from the coated region to the uncoated region of the electrode sheet, rotation of the supply bobbin; cutting a first cutting line located on the upstream side of the first boundary line with respect to the roll-to-roll travelling direction; and attaching the first cutting line of the uncoated region to a scrap winder.

The electrode manufacturing method may further include: cutting a second cutting line located on the downstream side of the second boundary line with respect to the roll-to-roll traveling direction; and rotating the scrap winder to wind the uncoated region on the scrap winder.

The electrode manufacturing method may further include: splicing the first cutting line and the second cutting line of the coated region; and resuming rotation of the supply bobbin.

The electrode manufacturing method may further include: monitoring a second separation distance from the outermost surface of the electrode sheet to the supply bobbin; and decelerating, when the second separation distance is less than or equal to a second reference value, a rotational speed of the supply bobbin.

The second separation distance may be obtained by calculating, during the roll-to-roll traveling, a difference between a distance from the first displacement sensor to the supply bobbin and a distance from the second displacement sensor to an outermost surface of the electrode sheet.

The second separation distance may be obtained by calculating, during the roll-to-roll traveling, a difference between a distance from the second displacement sensor to an outermost surface of the electrode sheet and a distance from the third displacement sensor to the supply bobbin.

The electrode manufacturing method may further include stopping rotation of the supply bobbin and then replacing it with another supply bobbin having another electrode sheet wound on a roll-to-roll traveling line.

According to an aspect of this disclosure, by more precisely distinguishing uncoated regions of an electrode sheet, the wasted amount of uncoated regions may be minimized, while keeping the wasted amount of the uncoated regions constant, thereby improving process reliability and efficiency.

However, the effects of this disclosure are not necessarily limited to the effects described above, and may be expanded in various ways without departing from the idea and scope of this disclosure.

### BRIEF DESCRIPTION OF THE DRAWINGS

A more complete appreciation of this disclosure and many of the attendant aspects thereof will be readily obtained as the same becomes better understood by reference to the following detailed description when considered in connection with the accompanying drawings, wherein:

FIG. 1 is a conceptual diagram schematically illustrating an electrode manufacturing apparatus according to an aspect.

FIG. 2 is a conceptual diagram schematically illustrating an arrangement relationship of the electrode sheet and the displacement sensor shown in FIG. 1.

FIG. 3 is a perspective view illustrating a detailed configuration of the electrode sheet shown in FIG. 1 in more detail.

FIG. 4 is a block diagram schematically illustrating a relationship between the controller and other components of the electrode manufacturing apparatus shown in FIG. 1.

FIG. 5 is a flowchart schematically illustrating an electrode manufacturing method according to an aspect.

FIG. 6 is a conceptual diagram to illustrate steps S1 to S5 of FIG. 5.

FIG. 7 is a conceptual diagram to illustrate step S5 of FIG. 5 in more detail.

FIG. 8 is a conceptual diagram to illustrate step S5 of FIG. 5 in more detail.

FIG. 9 is a conceptual diagram to illustrate step S6 of FIG. 5.

FIG. 10 is a graph illustrating steps S1 to S10 of FIG. 5 in terms of signals received by a displacement sensor.

### DETAILED DESCRIPTION

Hereinafter, this disclosure will be described in detail with reference to the accompanying drawings. However, this is illustrative only, and this disclosure is not limited to the specific aspect illustrated.

The terms used throughout the specification of the disclosure are intended to describe aspects and are not intended to limit the disclosure. For example, singular expressions may include the plural unless the context clearly indicates otherwise. Also, when a portion is stated to "include" a component, it is meant to be inclusive of other components, not exclusive of other components, unless otherwise specifically stated.

The phrases "at least one of X, Y, and Z" and "at least one selected from the group consisting of X, Y, and Z" may be interpreted as one X, one Y, one Z, or any combination of two or more of X, Y, and Z (e.g., XY, YZ, ZX, XYZ). As used herein, the term "and/or" includes any combination of one or more of those configurations.

When a part is stated to be "connected" to another part, this may include not only being "directly connected" but also being "indirectly connected" with another component interposed therebetween.

Terms such as first, second, or the like may be used to describe different components. These are used to distinguish one component from another when there is a plurality of components that perform the same function but are arranged in different locations. Accordingly, a first component may refer to a second component without departing from those disclosed herein.

Hereinafter, various aspects will be described with reference to the illustrative drawings. Accordingly, it is expected that the shapes may vary according to tolerances and/or the techniques applied. Accordingly, the aspects of this disclosure are illustrated with components conceptualized for ease of description and are not to be construed as necessarily limited to particular shapes or sizes. Likewise, the shapes illustrated in the drawings may not show actual shapes of areas of the device, and aspects of the disclosure are not necessarily limited thereto.

Certain sequences of processes may be performed differently from the order described when the aspect is otherwise feasible. For example, two processes described in succession may be performed substantially concurrently or performed in the opposite order from the order described.

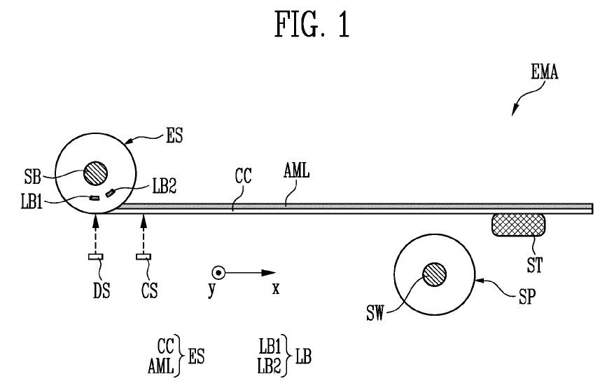

In the following, an electrode manufacturing apparatus EMA will be described with reference to FIGS. 1-4.

As used herein, a battery, secondary battery, and cell all refer to a battery cell that is equally capable of being charged and discharged.

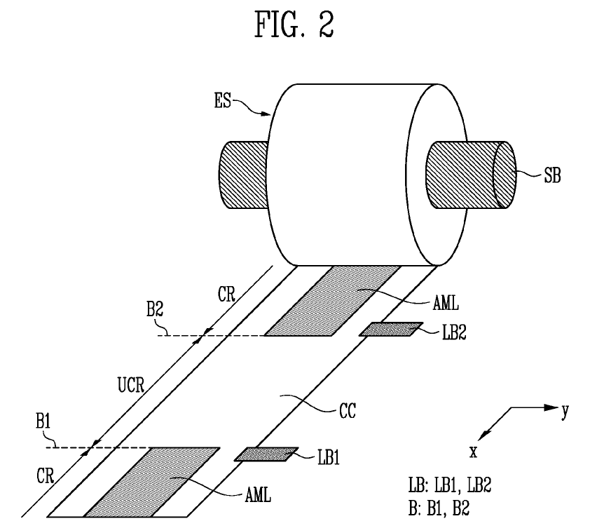

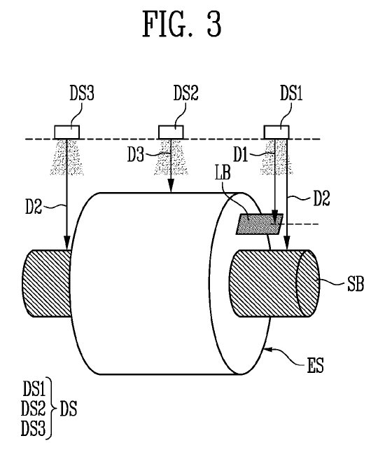

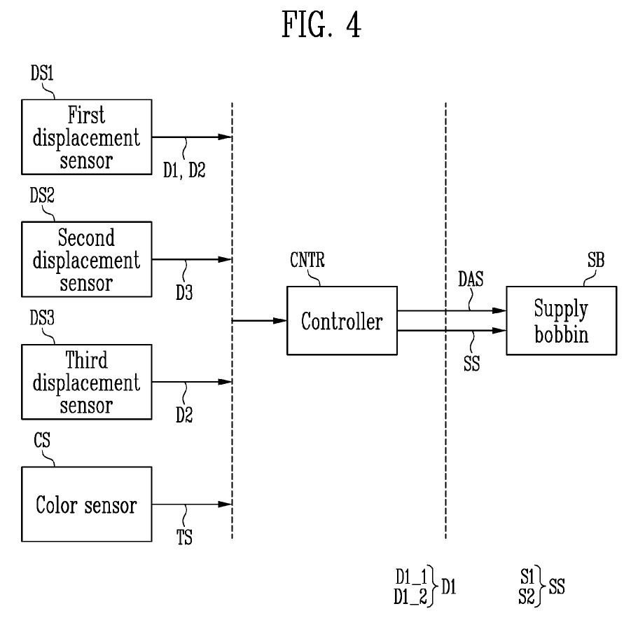

FIG. 1 is a conceptual diagram schematically illustrating an electrode manufacturing apparatus according to an aspect. FIG. 2 is a conceptual diagram schematically illustrating an arrangement relationship of the electrode sheet and the displacement sensor shown in FIG. 1. FIG. 3 is a perspective view illustrating a detailed configuration of the electrode sheet shown in FIG. 1 in more detail. FIG. 4 is a block diagram schematically illustrating a relationship between the controller and other components of the electrode manufacturing apparatus shown in FIG. 1.

Referring to FIGS. 1-4 together, an electrode manufacturing apparatus EMA of this disclosure may include a supply bobbin SB, an electrode sheet ES, a label LB, a first displacement sensor DS1, a second displacement sensor DS2, and a controller CNTR.

The supply bobbin SB is a component that performs roll-to-roll traveling, along the boundary of which the electrode sheet ES may be wound. The supply bobbin SB may transport the electrode sheet ES in a roll-to-roll traveling direction x through a rotational motion.

Referring to FIGS. 1 and 2, the electrode sheet ES may include a coated region CR and an uncoated region UCR, and may be wound on the supply bobbin SB. The electrode sheet ES may extend in a unidirectional direction, such as a sheet extending in the roll-to-roll traveling direction x.

The electrode sheet ES may be unwound and transferred in the roll-to-roll traveling direction x according to the rotation of the supply bobbin SB while being wound on the supply bobbin SB. For example, the electrode sheet ES may be transferred from a coating process to a roll pressing process during an electrode manufacturing process according to the rotation of the supply bobbin SB.

The electrode sheet ES may include a collector CC and an active material layer AML applied to a surface of the collector CC. The collector CC may include a metal as its material. For example, the collector CC may include aluminum (Al) for a positive electrode collector, or copper (Cu) for a negative electrode collector.

The active material layer AML may be applied to one side of the collector CC as shown in FIG. 1, but aspects are not necessarily limited thereto. For example, the active material layer AML may be applied to both sides of the collector CC. The active material layer AML may include a positive electrode active material and a negative electrode active material. The positive electrode active material may include lithium oxide (LiO) or high-nickel (High-Ni). The negative electrode active material may include a silicon/carbon (Si/C) composite material.

The active material layer AML may be applied to the coated region CR of the electrode sheet ES, and may not be applied to the uncoated region CR. A width of the active material layer AML applied to the coated region CR may be smaller than a width of the collector CC. In other words, based on the direction y intersecting the roll-to-roll traveling direction x, the width of the active material layer AML applied to the coated region CR may be smaller than the width of the collector CC. The portions of the collector CC arranged on one side and the other side of the active material layer AML in the coated region CR may be cut in the slitting and notching process during the electrode manufacturing process and processed into electrode tabs (not shown).

The label LB may be attached to the boundary line B of the coated region CR and the uncoated region UCR. The boundary line B may include a first boundary line B1 on which transition occurs from a coated region CR to an uncoated region UCR, and a second boundary line B2 on which transition occurs from the uncoated region UCR to the coated region CR.

The label LB may include a first label LB1 arranged on an upstream side of the first boundary line B1 relative to the roll-to-roll traveling direction x, and a second label LB2 arranged on a downstream side of the second boundary line B2 relative to the roll-to-roll traveling direction y.

The label LB may be applied manually or automatically in a process prior to the electrode sheet ES being wound on the supply bobbin SB. For example, the label LB may be manually attached by an operator during the coating process of the electrode sheet ES, or automatically applied by a mechanical device.

Referring to FIGS. 1 and 3 together, a first displacement sensor DS1 may be spaced apart from the electrode sheet ES to selectively detect any one of a first distance D1 to the label LB and a second distance D2 to the supply bobbin SB during the roll-to-roll traveling. The second displacement sensor DS2 may be spaced apart from the electrode sheet ES to detect a third distance D3 to an outermost surface of the electrode sheet ES during the roll-to-roll traveling.

The first displacement sensor DS1 may detect the second distance D2 to the supply bobbin SB at all times during the roll-to-roll traveling, and may temporarily detect the first distance D1 to the label LB when the label LB is positioned between the first displacement sensor DS1 and the supply bobbin SB. In aspects, the term "selectively" is an expression indicating that the first displacement sensor DS1 may detect both the first distance D1 and the second distance D2, but may only detect one of them at any given moment.

The electrode manufacturing apparatus EMA may further include a third displacement sensor DS3 that detects the second distance D2 to the supply bobbin SB during the roll-to-roll traveling. The third displacement sensor DS3 may only detect the second distance D2 to the supply bobbin SB at all times during the roll-to-roll traveling, such that it may play a role in assisting the first displacement sensor DS1, which is unable to detect the second distance D2 while detecting the first distance D1.

The first displacement sensor DS1, the second displacement sensor DS2, and the third displacement sensor DS3 are components detecting the separation distance from moving objects such as the supply bobbin SB, electrode sheet ES, and label LB rotating about the supply bobbin SB with the electrode sheet ES, and may be a non-contact displacement sensor to prevent collision with the objects. For example, the first displacement sensor DS1, the second displacement sensor DS2, and the third displacement sensor DS3 may be any one of a laser displacement sensor, an ultrasonic displacement sensor, an optical displacement sensor, a capacitive displacement sensor, and an infrared displacement sensor.

Referring to FIGS. 1 and 4 together, the controller CNTR may optionally receive an electrical signal from the first displacement sensor DS1 for any one of the first distance D1 and the second distance D2. The controller CNTR may receive an electrical signal for a third distance D3 from the second displacement sensor DS2. The controller CNTR may receive an electrical signal for the second distance D2 from the third displacement sensor DS3 at all times.

The controller CNTR may adjust the rotational speed of the supply bobbin SB based on a difference between the first distance D1 and the third distance D3. For example, the controller CNTR may transmit to the supply bobbin SB a deceleration signal DAS to decelerate the rotational speed of the supply bobbin SB when the difference between the first distance D1 and the third distance D3 is less than or equal to a first reference value RV1 (D1-D3≤RV1).

A state in which a difference between the first distance D1 and the third distance D3 is approaching zero may indicate that the unwinding of the boundary line B is imminent. The first reference value RV1 may be set to a suitable value such that the controller CNTR may recognize this situation in advance before the uncoated region UCR is unwound from the supply bobbin SB and prepare to decelerate the rotational speed of the supply bobbin SB.

As such, when the rotational speed of the supply bobbin SB is decelerated in advance in preparation for the unwinding of the uncoated region UCR, the rotation of the supply bobbin SB may be stopped so that the boundary line B is accurately and consistently positioned at the location where the uncoated region UCR is removed.

By stopping the rotation of the supply bobbin SB at the right time, the electrode manufacturing apparatus EMA of this disclosure may more precisely distinguish the uncoated region UCR and minimize the wasted amount of the coated region CR. Furthermore, by stopping the rotation of the supply bobbin SB at a consistent time, the electrode manufacturing method of this disclosure may improve process reliability and efficiency by keeping the wasted amount of uncoated region UCR constant even when the process is repeated.

Referring to FIGS. 2 and 4 together, the first displacement sensor DS1 may selectively detect any one of a first_first distance D1_1 to the first label LB1 and to a second distance D2 to the supply bobbin SB during the roll-to-roll traveling, and any one of a first_second distance D1_2 to the second label LB2 and to a second distance D2 to the supply bobbin SB during the roll-to-roll traveling.

As such, when the label LB includes a first label LB1 and a second label LB2, the controller CNTR may selectively receive an electrical signal from the first displacement sensor DS1 for any one of the first_first distance D1_1 and the second distance D2, and may selectively receive an electrical signal for any one of the first_second distance D1_2 and the second distance D2. Based on this, the controller CNTR may decelerate the rotational speed of the supply bobbin SB when the difference between the first_first distance D1_1 and a third distance D3 is less than or equal to a first reference value RV1 (D1_1-D3≤RV1), and when the difference between the first_second distance D1_2 and the third distance D3 is less than or equal to the first reference value RV1 (D1_2-D3≤RV1), a deceleration signal DAS to decelerate the rotational speed of the supply bobbin SB may be transmitted to the supply bobbin SB.

A state in which a difference between the first_first distance D1_1 and the third distance D3 is approaching zero may indicate that the unwinding of the first boundary line B1 is imminent. Also, a state in which a difference between the first_second distance D1_2 and the third distance D3 is approaching zero may indicate that the unwinding of the second boundary line B2 is imminent. The first reference value RV1 may be set to a suitable value such that the controller CNTR may recognize this situation in advance before each of the first boundary line B1 and the second boundary line B2 is unwound from the supply bobbin SB and prepare to decelerate the rotational speed of the supply bobbin SB.

As such, when the rotational speed of the supply bobbin SB is decelerated in advance in preparation for the unwinding of the uncoated region UCR, the rotation of the supply bobbin SB may be stopped so that the first boundary line B1 and the second boundary line B2 are accurately and consistently positioned at the location where the uncoated region UCR is removed.

By stopping the rotation of the supply bobbin SB at the right time, the electrode manufacturing apparatus EMA of this disclosure may more precisely distinguish the uncoated region UCR to minimize the wasted amount of the coated region CR. Furthermore, by stopping the rotation of the supply bobbin SB at a consistent time, the electrode manufacturing apparatus EMA of this disclosure may keep the wasted amount of the uncoated region UCR constant even when the process is repeated, thereby improving process reliability and efficiency.

Further, the controller CNTR may adjust the rotational speed of the supply bobbin SB based on the difference between the second distance D2 and the third distance D3. For example, the controller CNTR may transmit to the supply bobbin SB a deceleration signal DAS to decelerate the rotational speed of the supply bobbin SB when the difference between the second distance D2 and the third distance D3 is less than or equal to a second reference value RV2 (D2-D3≤RV2).

The difference between the second distance D2 and the third distance D3 may represent the roll diameter of the electrode sheet ES. In other words, the deceleration of the rotational speed of the supply bobbin SB may start at the moment when the roll diameter of the electrode sheet ES is equal to the preset second reference value RV2. The controller CNTR may transmit to the supply bobbin SB a stop signal SS to stop the rotation of the supply bobbin SB after decelerating the rotation of the supply bobbin SB for a predetermined time.

Referring to FIGS. 1, 2, and 4, together, the electrode manufacturing apparatus EMA may further include a color sensor CS.

The color sensor CS may be spaced apart from the electrode sheet ES to distinguish and detect coated regions CR and uncoated regions UCR during the roll-to-roll traveling.

The color sensor CS may detect a moment of transition from the coated region CR to the uncoated region UCR and transmit a stop signal SS to the controller CNTR. In other words, the color sensor CS may detect the moment when the active material layer AML breaks at the first boundary line B1 during the roll-to-roll traveling. The controller CNTR may stop the rotation of the supply bobbin SB based on the stop signal received from the color sensor CS. For example, the controller CNTR may stop rotation of the supply bobbin SB so that the first boundary line B1 is positioned on the splicing table ST.

Referring again to FIG. 1, the electrode manufacturing apparatus EMA may further include a scrap winder SW.

The scrap winder SW may wind an uncoated region UCR of the electrode sheet ES. In aspects, the uncoated region UCR may be removed from the electrode sheet by cutting a first cutting line CL1 located on the upstream side of the first boundary line B1 and a second cutting line CL2 located on the downstream side of the second boundary line B2 with respect to the roll-to-roll traveling direction x, between the moments when the rotation of the supply bobbin SB is stopped by the stop signal SS.

The electrode manufacturing apparatus EMA may further include a splicing table ST.

The splicing table ST may provide a space where the cutting of the first cutting line CL1 and splicing of the first cutting line CL1 and the second cutting line CL2 of the coated region CR take place.

The cutting may be performed manually by an operator. For example, the operator may use a cutting tool to cut the first cutting line CL1 while the first boundary line B1 is positioned on the splicing table ST. Subsequently, the operator may attach the first cutting line CL1 of the uncoated region UCR to the scrap winder SW, and then cut the second cutting line CL2 in that state. The operator may directly cut the first cutting line CL1 and the second cutting line CL2; however, aspects are not necessarily limited thereto. For example, the first cutting line CL1 and the second cutting line CL2 may be automatically cut by an automatically controlled cutting mechanism (not shown).

The splicing may be performed automatically by a separate splicing mechanism (not shown). For example, after the cutting of the first cutting line CL1 and the second cutting line CL2 is completed, the supply bobbin SB may advance the electrode sheet ES a predetermined distance so that the first cutting line CL1 and the second cutting line CL2 of the coated region meet each other on the splicing table ST.

As such, with the first cutting line CL1 and the second cutting line CL2 of the coated region in contact with each other on the splicing table ST, the first cutting line CL1 and the second cutting line CL2 may be spliced by the splicing mechanism. In other words, as the uncoated region UCR of the electrode sheet ES is removed, the electrode sheet ES may be transferred to a subsequent process with the coated region CR continuously formed.

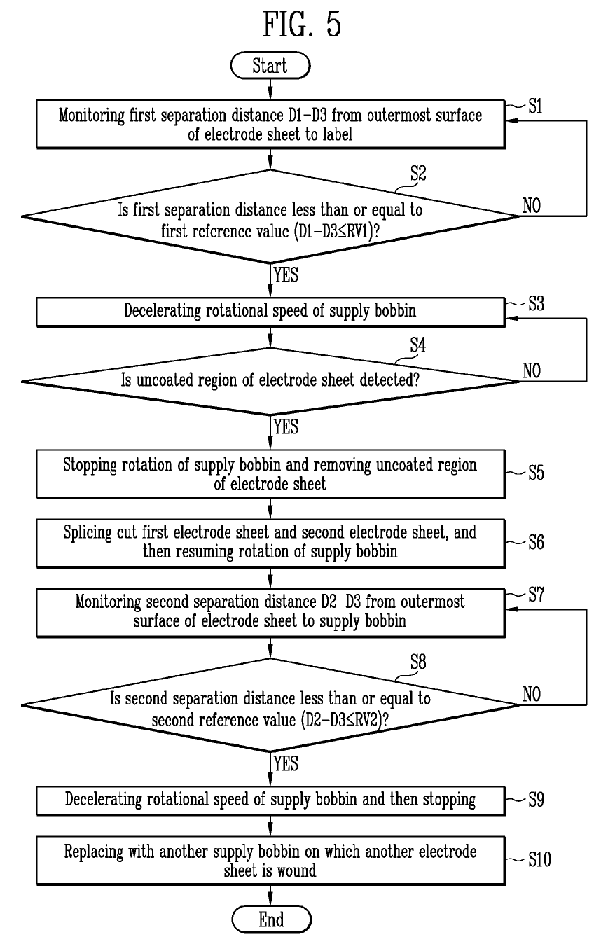

Hereinafter, an electrode manufacturing method will be described with reference to FIGS. 5-10.

In this disclosure, the electrode manufacturing method is directed to a method of manufacturing an electrode using an electrode manufacturing apparatus EMA described with reference to FIGS. 1-4, and the description of the detailed components of the electrode manufacturing apparatus EMA is based on the aforementioned description. Accordingly, detailed description of other matters related to the electrode manufacturing method will be omitted in the following.

FIG. 5 is a flowchart schematically illustrating an electrode manufacturing method according to an aspect.

Referring to FIG. 5, an electrode manufacturing method of this disclosure may include: monitoring a first separation distance D1-D3 from an outermost surface of an electrode sheet ES wound on a supply bobbin SB and traveling roll-to-roll to a label LB S1; determining whether the first separation distance D1-D3 is less than or equal to a first reference value RV1 S2; and decelerating, when the first separation distance D1-D3 is less than or equal to the first reference value RV1, the rotational speed of the supply bobbin SB S3. The label LB may be attached to the boundary line B of the coated region CR and the uncoated region UCR of the electrode sheet ES.

Referring to FIGS. 3 and 5 together, the first separation distance D1-D3 may be obtained by calculating, during the roll-to-roll traveling, a difference between a distance D1 from the first displacement sensor DS1 to the label LB and a distance D3 from the second displacement sensor DS2 to an outermost surface of the electrode sheet ES.

A state in which the first separation distance D1-D3 is approaching zero may indicate that the unwinding of the uncoated region UCR is imminent. The first reference value RV1 may be set to a suitable value such that the controller CNTR may recognize this situation before the uncoated region UCR is unwound from the supply bobbin SB and prepare deceleration of the rotational speed of the supply bobbin SB.

As such, when the rotational speed of the supply bobbin SB is decelerated in advance in preparation for the unwinding of the uncoated region UCR, the rotation of the supply bobbin SB may be stopped so that the first boundary line B1 and the second boundary line B2 are accurately and consistently positioned at the location where the uncoated region UCR is removed.

By stopping the rotation of the supply bobbin SB at the right time, the electrode manufacturing method of this disclosure may enable more precise distinguishing of the uncoated region UCR, thereby minimizing the wasted amount of the coated region CR. Furthermore, by stopping the rotation of the supply bobbin SB at a consistent time, the electrode manufacturing method of this disclosure may improve process reliability and efficiency by keeping the wasted amount of uncoated region UCR constant even when the process is repeated.

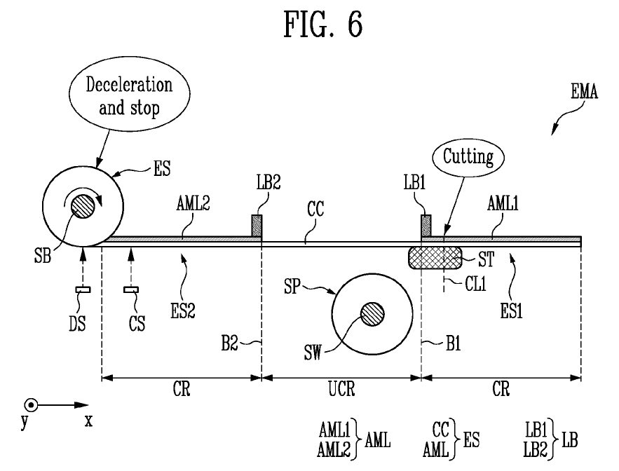

Referring to FIGS. 5 and 6 together, the boundary line B may include a first boundary line B1 on which transition occurs from the coated region CR to the uncoated region UCR, and a second boundary line B2 on which transition occurs from the uncoated region UCR to the coated region CR, the label LB may include a first label LB1 arranged on an upstream side of the uncoated region UCR relative to the roll-to-roll traveling direction x, and a second label LB2 arranged on a downstream side of the uncoated region UCR relative to the roll-to-roll traveling direction y.

As such, when the label LB consists of the first label LB1 and the second label LB2, the first separation distance D1_1-D3 may be obtained by calculating, during the roll-to-roll traveling, a difference between a distance D1_1 from the first_first displacement sensor DS1_1 to the first label LB1 and a third distance D3 from the second displacement sensor DS2 to an outermost surface of the electrode sheet ES.

A state in which the first separation distance D1_1-D3 is approaching zero may indicate that the unwinding of the first boundary line B1 is imminent. The first reference value RV1 may be set to a suitable value such that the controller CNTR may recognize this situation in advance before the first boundary line B1 is unwound from the supply bobbin SB and prepare for deceleration of rotational speed of the supply bobbin SB.

As such, when the rotational speed of the supply bobbin SB is decelerated in advance in preparation for the unwinding of the uncoated region UCR, the rotation of the supply bobbin SB may be stopped so that the first boundary line B1 and the second boundary line B2 are accurately and consistently positioned at the location where the uncoated region UCR is removed.

By stopping the rotation of the supply bobbin SB at the right time, the electrode manufacturing method of this disclosure may enable more precise distinguishing of the uncoated region UCR, thereby minimizing the wasted amount of the coated region CR. Furthermore, by stopping the rotation of the supply bobbin SB at a consistent time, the electrode manufacturing apparatus EMA of this disclosure may improve process reliability and efficiency by keeping the wasted amount of uncoated region UCR constant even when the process is repeated.

Further, the electrode manufacturing method of this disclosure may include: determining whether an uncoated region UCR of the electrode sheet ES is detected S4; stopping, when detecting the uncoated region UCR of the electrode sheet ES, the rotation of the supply bobbin SB and removing the uncoated region UCR of the electrode sheet ES S5; resuming, after splicing the cut first electrode sheet ES1 and the second electrode sheet ES2, the rotation of the supply bobbin SB S6; monitoring a second separation distance D2-D3 from an outermost surface of the electrode sheet ES to the supply bobbin SB S7; determining whether the second separation distance D2-D3 is less than or equal to a second reference value RV2 S8; when the second separation distance D2-D3 is less than or equal to the second reference value RV2, stopping after decelerating the rotational speed of the supply bobbin SB S9; and replacing with another supply bobbin SB having another electrode sheet (not shown) wound thereon S10.

Hereinafter, S1 to S10 of FIG. 5 will be described in more detail with reference to FIGS. 6-10.

FIG. 6 is a conceptual diagram to illustrate steps S1 to S5 of FIG. 5.

Referring to FIG. 6, through steps S1 to S4 described above, the supply bobbin SB may be decelerated and stopped according to the deceleration signal DAS and the stop signal SS received from the controller CNTR. In other words, the controller CNTR may decelerate the rotational speed of the supply bobbin SB as the first separation distance D1_1-D3 calculated by the controller CNTR is less than or equal to the first reference value RV1 S1, S2, S3, and may stop the rotation of the supply bobbin SB when the color sensor CS detects a moment of transition from the coated region CR to the uncoated region UCR of the electrode sheet ES S4, S5.

In step S5 in which the rotation of the supply bobbin SB is stopped, the first label LB1 attached to the electrode sheet ES may be positioned on the splicing table ST. In this state, the first cutting line CL1 located on the upstream side of the first boundary line B1 with respect to the roll-to-roll traveling direction x may be cut. In other words, a leading end of the uncoated region UCR may be cut along the first cutting line CL1.

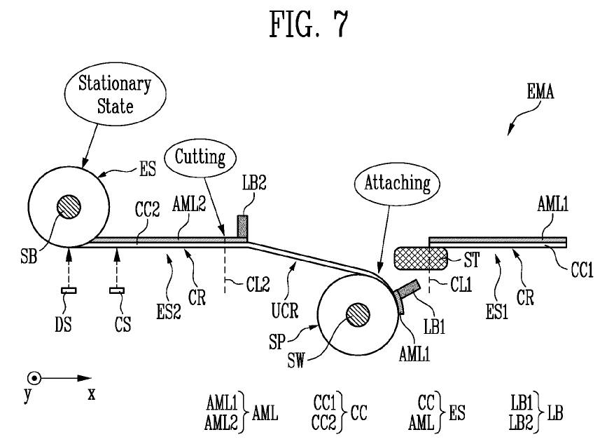

FIG. 7 is a conceptual diagram to illustrate step S5 of FIG. 5 in more detail.

Referring to FIG. 7, with the supply bobbin SB remaining in a stationary state, the cut first cutting line CL1 of the uncoated region UCR may be attached to the scrap winder SW. In this state, a second cutting line CL2 located on the downstream side of the second boundary line B2 with respect to the roll-to-roll traveling direction x may also be cut. In other words, a trailing end of the uncoated region UCR may be cut along the second cutting line CL2.

Due to the cutting of the first cutting line CL1 and the second cutting line CL2, the collector CC may be separated into a first collector CC1 on the upstream side of the uncoated region UCR and a second collector CC2 on the downstream side of the uncoated region UCR.

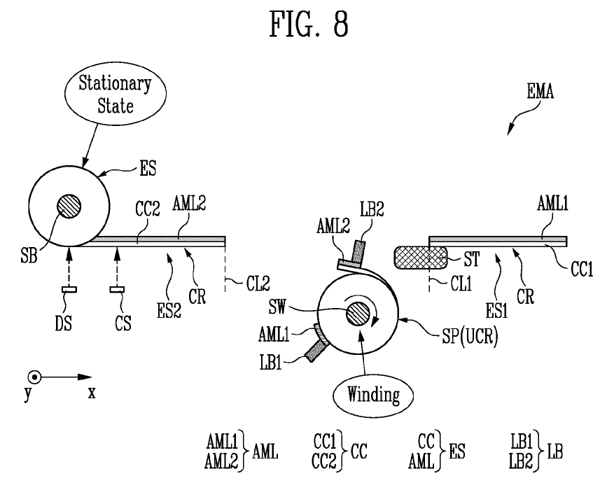

FIG. 8 is a conceptual diagram to illustrate step S5 of FIG. 5 in more detail.

Referring to FIG. 8, after the cutting of the first cutting line CL1 and the second cutting line CL2 is completed, the first cutting line CL1 of the uncoated region UCR is attached to the scrap winder SW. In this state, the scrap winder SW may be rotated to wind the uncoated region UCR onto the scrip winder SW.

As described above, the removing the uncoated regions UCR of the electrode sheet ES may be performed repeatedly, such that a plurality of uncoated regions UCR may be accumulated and wound on the scrap winder SW.

As such, the scrap winder SW may store scrap pieces SP with the uncoated regions UCR accumulated and wound. The scrap pieces SP may be discarded or recycled into electrode sheets ES. As the length of the scrap pieces SP may be easily determined by measuring the roll diameter of the scrap winder SW or by unwinding the scrap winder SW, the efficiency of the electrode manufacturing process may be improved by statistically databasing the wasted amount.

The scrap winder SW may rotate automatically, but aspects are not necessarily limited thereto. For example, the scrap winder SW may be manually rotated by an operator. In aspects, when the length of the uncoated region UCR is too long for the operator to manually maneuver to advance, the supply bobbin SB may resume rotation instead of rotating the scrap winder SW.

With the second boundary line B2 positioned on the splicing table ST, the second boundary line B2 of the uncoated region UCR and the coated region CR may be cut. In other words, a trailing end of the uncoated region UCR may be cut along the second boundary line B2.

After cutting the second boundary line B2, the scrap winder SW may be rotated to wind the uncoated region UCR on the scrap winder SW.

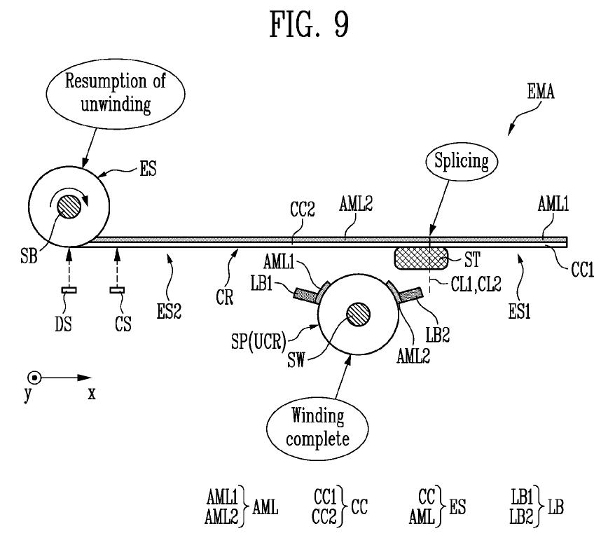

FIG. 9 is a conceptual diagram to illustrate step S6 of FIG. 5.

Referring to FIG. 9, after splicing the first cutting line CL1 and the second cutting line CL2 of the coated region CR, the unwinding of the supply bobbin SB may be resumed. In other words, after splicing the first cutting line CL1 and the second cutting line CL2 of the coated region to connect the first electrode sheet ES1 and the second electrode sheet ES2 that are separated by the uncoated region UCR, the supply bobbin SB may be rotated again to transfer the electrode sheet ES back to the subsequent process.

As such, in the step of splicing the first cutting line CL1 and the second cutting line CL2 of the coated region CR, the scrap winder SW may complete the unwinding of the scrap piece SP.

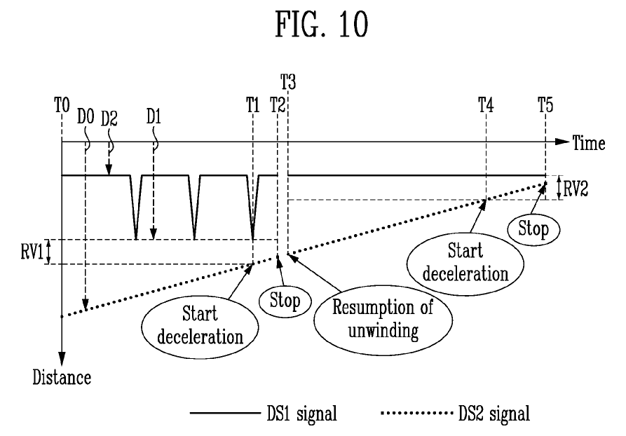

FIG. 10 is a graph illustrating steps S1 to S10 of FIG. 5 in terms of signals received by the displacement sensor.

FIG. 10 is a graph of values (y-axis) of distance signals detected by the first displacement sensor DS1 and the second displacement sensor DS2 over the time period from T0 to T5 (x-axis), with T0 as a reference point.

Referring to FIG. 10, D1 represents the first distance from the first displacement sensor DS1 to the label LB. D2 represents the second distance from the first displacement sensor DS1 or the third displacement sensor DS3 to the supply bobbin SB. D3 represents the third distance from the second displacement sensor DS2 to an outermost surface of the electrode sheet ES.

In the interval from time T0 to time T1, the supply bobbin SB may be continuously rotated while monitoring the first separation distance D1-D3 from an outermost surface of the electrode sheet ES to the label LB S1. Accordingly, it may be seen that a value of a distance signal detected by the first displacement sensor DS1 remains at a constant level, and then the value of the distance signal detected by the first displacement sensor DS1 exhibits a downward spike at three moments at which the label LB is positioned between the first displacement sensor DS1 and the supply bobbin SB.

Time T1 is the moment at which the difference between the first distance D1 and the third distance D3 becomes equal to the first reference value RV1 S2, at which point the controller CNTR may transmit a deceleration signal DAS to the supply bobbin SB to start decelerating the supply bobbin SB S3.

In the interval from time T1 to time T2, the supply bobbin SB may continue to decelerate while determining whether an uncoated region UCR of the electrode sheet ES is detected S4.

When it is determined that the uncoated region UCR of the electrode sheet ES is detected at some moment between time T1 and time T2 S4, the controller CNTR may transmit a stop signal SS to the supply bobbin SB to stop the rotation of the supply bobbin SB at time T2 S5.

In the interval from time T2 to time T3, the uncoated region UCR of the electrode sheet ES may be removed, and the cut first electrode sheet ES1 and the second electrode sheet ES2 may be spliced S5.

The time T3 may be a moment of connecting the first electrode sheet ES1 and the second electrode sheet ES2 by splicing the first boundary line B1 and the second boundary line B2, and then resuming the rotation of the supply bobbin SB S6.

In the interval from time T3 to time T4, the second separation distance D2-D3 from an outermost surface of the electrode sheet ES to the supply bobbin SB may be monitored while the rotation of the supply bobbin SB is resumed S7. In aspects, the rotational speed of the supply bobbin SB may be decelerated when the second separation distance D2-D3 is less than or equal to a second reference value. The second separation distance D2-D3 may be obtained by calculating, during the roll-to-roll traveling, a difference between the distance D2 from the first displacement sensor DS1 to the supply bobbin SB and the distance D3 from the second displacement sensor DS2 to an outermost surface of the electrode sheet ES. Alternatively, the second separation distance D2-D3 may be obtained by calculating the difference between the distance D3 from the second displacement sensor DS2 to an outermost surface of the electrode sheet ES and the distance D2 from the third displacement sensor DS3 to the supply bobbin SB during roll-to-roll traveling.

Time T4 is a moment when the difference between the second distance D2 and the third distance D3 is equal to the second reference value RV2 S8, at which point the controller CNTR may transmit a deceleration signal DAS to the supply bobbin SB to start deceleration of the supply bobbin SB S9.

During the interval from time T4 to time T5, the supply bobbin SB may continue to decelerate, and at time T5, the rotation of the supply bobbin SB may stop completely S9.

At time T5, while the rotation of the supply bobbin SB is stopped, the supply bobbin SB with the electrode sheet ES fully unwound may be separated from the roll-to-roll traveling line and replaced with another supply bobbin (not shown) with another electrode sheet ES (not shown) wound on the roll-to-roll traveling line S10, to continue the electrode manufacturing process.

As such, when the rotational speed of the supply bobbin SB is decelerated in advance in preparation for the uncoated region UCR being wound, the rotation of the supply bobbin SB may be stopped so that the first boundary line B1 and the second boundary line B2 are accurately and consistently positioned at the location where the uncoated region UCR is removed.

By stopping the rotation of the supply bobbin SB at the right time, the electrode manufacturing method of this disclosure may enable more precise distinguishing of the uncoated region UCR, thereby minimizing the wasted amount of the coated region CR. Furthermore, by stopping the rotation of the supply bobbin SB at a consistent time, the electrode manufacturing method of this disclosure may improve process reliability and efficiency by keeping the wasted amount of uncoated region UCR constant even when the process is repeated.

This disclosure may be practiced in various modifications, and the scope of the disclosure is not limited to the above-described aspects. Accordingly, variations should be considered to fall within the scope of the disclosure when including components of the patent claims of this disclosure.

What is claimed is:

1. An electrode manufacturing apparatus comprising:
a supply bobbin configured to perform roll-to-roll traveling;
an electrode sheet including a coated region and an uncoated region and configured to be wound on the supply bobbin;
a label configured to be attached to a boundary line of the coated region and the uncoated region;
a first displacement sensor configured to be spaced apart from the electrode sheet and configured to selectively detect any one of a first distance to the label and a second distance to the supply bobbin during the roll-to-roll traveling;
a second displacement sensor configured to be spaced apart from the electrode sheet and configured to detect a third distance to an outermost surface of the electrode sheet during the roll-to-roll traveling; and
a controller configured to adjust a rotational speed of the supply bobbin based on a difference between the first distance and the third distance.

2. The electrode manufacturing apparatus according to claim 1, wherein the first displacement sensor:
is configured to temporarily detect, when the label is positioned between the first displacement sensor and the supply bobbin, a first distance from the first displacement sensor to the label, and
is configured to detect the second distance from the first displacement sensor to the supply bobbin at all times.

3. The electrode manufacturing apparatus according to claim 1, wherein the controller is configured to decelerate, when a difference between the first distance and the third distance is less than or equal to a first reference value, a rotational speed of the supply bobbin.

4. The electrode manufacturing apparatus according to claim 1, wherein the boundary line comprises:
a first boundary line on which transition occurs from a coated region to an uncoated region; and
a second boundary line on which transition occurs from the uncoated region to the coated region;
wherein the label includes:
a first label configured to be arranged on an upstream side of the first boundary line relative to a roll-to-roll traveling direction; and
a second label configured to be arranged on a downstream side of the second boundary line relative to the roll-to-roll traveling direction,
wherein the first displacement sensor:
is configured to selectively detect any one of a first_first distance to the first label and the second distance to the supply bobbin during the roll-to-roll traveling, and
is configured to selectively detect any one of a first_second distance to the second label and the second distance to the supply bobbin during the roll-to-roll traveling, and
wherein the controller:
is configured to decelerate, when a difference between the first_first distance and the third distance is less than or equal to a first reference value, a rotational speed of the supply bobbin, and
is configured to decelerate, when a difference between the first_second distance and the third distance is less than or equal to the first reference value, a rotational speed of the supply bobbin.

5. The electrode manufacturing apparatus according to claim 1, wherein the controller is configured to decelerate, when a difference between the second distance and the third distance is less than or equal to a second reference value, the rotational speed of the supply bobbin.

6. The electrode manufacturing apparatus according to claim 4, further comprising a color sensor configured to be spaced apart from the electrode sheet and configured to distinguish and detect the coated region and the uncoated region during the roll-to-roll traveling.

7. The electrode manufacturing apparatus according to claim 6, wherein the color sensor is configured to detect a moment of transition from the coated region to the uncoated region and transmits a stop signal to the controller, and
wherein the controller is configured to stop rotation of the supply bobbin based on the stop signal.

8. The electrode manufacturing apparatus according to claim 7, further comprising a scrap winder configured to wind the uncoated region of the electrode sheet,
wherein the uncoated region is removed from the electrode sheet by cutting a first cutting line located on the upstream side of the first boundary line and a second cutting line located on the downstream side of the second boundary line with respect to the roll-to-roll travelling direction between the moments when rotation of the supply bobbin stops by the stop signal.

9. The electrode manufacturing apparatus according to claim 8, further comprising a splicing table on which cutting of the first cutting line and splicing of the first cutting line and the second cutting line take place.

10. The electrode manufacturing apparatus according to claim 1, further comprising a third displacement sensor configured to detect a second distance to the supply bobbin during the roll-to-roll traveling.

11. An electrode manufacturing method comprising:
monitoring a first separation distance from an outermost surface of an electrode sheet wound on a supply bobbin and performing roll-to-roll traveling to a label; and
decelerating a rotational speed of the supply bobbin when the first separation distance is less than or equal to a first reference value,
wherein the label is attached to a boundary line of a coated region and an uncoated region of the electrode sheet.

12. The electrode manufacturing method according to claim 11, wherein the first separation distance is obtained by calculating, during the roll-to-roll traveling, a difference between a distance from a first displacement sensor to the label and a distance from a second displacement sensor to an outermost surface of the electrode sheet.

13. The electrode manufacturing method according to claim 11, wherein the boundary line comprises:
a first boundary line on which transition occurs from a coated region to an uncoated region, and
a second boundary line on which transition occurs from the uncoated region to the coated region,
wherein the label includes:
a first label arranged on an upstream side of the first boundary line relative to a roll-to-roll traveling direction; and
a second label arranged on a downstream side of the second boundary line relative to the roll-to-roll traveling direction, and
wherein the first separation distance is obtained by calculating, during the roll-to-roll traveling, a difference between a first_first distance from the first displacement sensor to the first label and a third distance from the second displacement sensor to an outermost surface of the electrode sheet.

14. The electrode manufacturing method according to claim 13, further comprising:
stopping, when detecting a moment of transition from the coated region to the uncoated region of the electrode sheet, rotation of the supply bobbin;
cutting a first cutting line located on the upstream side of the first boundary line with respect to the roll-to-roll traveling direction; and
attaching the first cutting line of the uncoated region to a scrap winder.

15. The electrode manufacturing method according to claim 14, further comprising:
cutting a second cutting line located on the downstream side of the second boundary line with respect to the roll-to-roll traveling direction; and
rotating the scrap winder to wind the uncoated region on the scrap winder.

16. The electrode manufacturing method according to claim 15, further comprising:
splicing the first cutting line and the second cutting line of the coated region; and
resuming rotation of the supply bobbin.

17. The electrode manufacturing method according to claim 12, further comprising:
monitoring a second separation distance from the outermost surface of the electrode sheet to the supply bobbin; and
decelerating, when the second separation distance is less than or equal to a second reference value, a rotational speed of the supply bobbin.

18. The electrode manufacturing method according to claim 17, wherein the second separation distance is obtained by calculating, during the roll-to-roll traveling, a difference between a distance from the first displacement sensor to the supply bobbin and a distance from the second displacement sensor to the outermost surface of the electrode sheet.

19. The electrode manufacturing method according to claim 17, wherein the second separation distance is obtained by calculating, during the roll-to-roll traveling, a difference between a distance from the second displacement sensor to the outermost surface of the electrode sheet and a distance from the third displacement sensor to the supply bobbin.

20. The electrode manufacturing method according to claim 17, further comprising stopping rotation of the supply bobbin and then replacing it with another supply bobbin having another electrode sheet wound on a line where the roll-to-roll traveling takes place.
